(19) United States
(12) Patent Application Publication
(10) Pub. No.: US 2005/0284402 A1
(43) Pub. Date: Dec. 29, 2005

(54) Pet door

(76) Inventor: Kent Becker, Huntertown, IN (US)

Correspondence Address: TAYLOR & AUST, P.C., 142 SOUTH MAIN STREET, P. O. BOX 560, AVILLA, IN, 46710, US

(21) Appl. No.: 11/150,626

(22) Filed: Jun. 9, 2005

Related U.S. Application Data
(60) Provisional application No. 60/579,743, filed on Jun. 15, 2004.

(51) Int. Cl. A01K 1/035

(52) U.S. Cl. 119/484

(57) ABSTRACT

A pet door including a retracting exterior door revealing a passageway when open and an inner flexible door that covers the passageway.

### CROSS REFERENCE TO RELATED APPLICATIONS

This is a non-provisional application based upon U.S. provisional patent application Ser. No. 60/579,743, entitled “PET DOOR”, filed Jun. 15, 2004.

### BACKGROUND OF THE INVENTION

1. Field of the Invention

The present invention relates to a pet entrance door, and, more particularly, to an automated pet entrance door.

2. Description of the Related Art

Pet doors are known in the art, which include flexible flaps over an opening in a wall or door to allow a pet to have access to a house. The pet normally presses against the flexible flap allowing the pet to displace the flap and enter the house. The flap is non-insulated and can be very uneconomical during inclement weather. This sort of pet door offers little or no security, allowing other animals or even people to have access to the home.

Pet doors available on the market today often consist of a soft plastic or aluminum material, which hang by gravity, typically in a swinging manner and are sealed by a magnetic device. Other doors have an overlapping of plastic material in such a way as to prevent excessive weather penetration. These sorts of pet doors operate by way of the pet having to push against the door or flap with its head in order to enter or exit.

Automatic opening doors for pets are also known, which lock when closed to prevent unauthorized access into a home.

What is needed in the art is a pet door that controls access yet reduces the amount of air that enters or exits the home.

### SUMMARY OF THE INVENTION

The present invention provides a pet door that both retracts based upon identification of the pet and provides a weather flap door.

The invention comprises, in one form thereof, a pet door including a retracting exterior door revealing a passageway when open and an inner flexible door that covers the passageway.

An advantage of the present invention is that the pet door is opened based upon the identification of an approaching animal and still maintains a weather resistant inner barrier to the weather until the pet overcomes the seal of the inner flexible door in order to enter the home.

Another advantage of the present invention is that as soon as the pet is in, the inner door closes and the outer door closes, thereby creating an insulative space therebetween.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a front view of an embodiment of the pet door of the present invention;

FIG. 2 is a partially sectioned side view of the pet door of FIG. 1;

FIG. 3 illustrates, in a cross-sectional manner, a portion of the upper part of the pet door of FIGS. 1 and 2;

FIG. 4 is another view of FIG. 3 with the door retracted; and

FIG. 5 illustrates the installation of the pet door of FIGS. 1-4 in a residential door.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

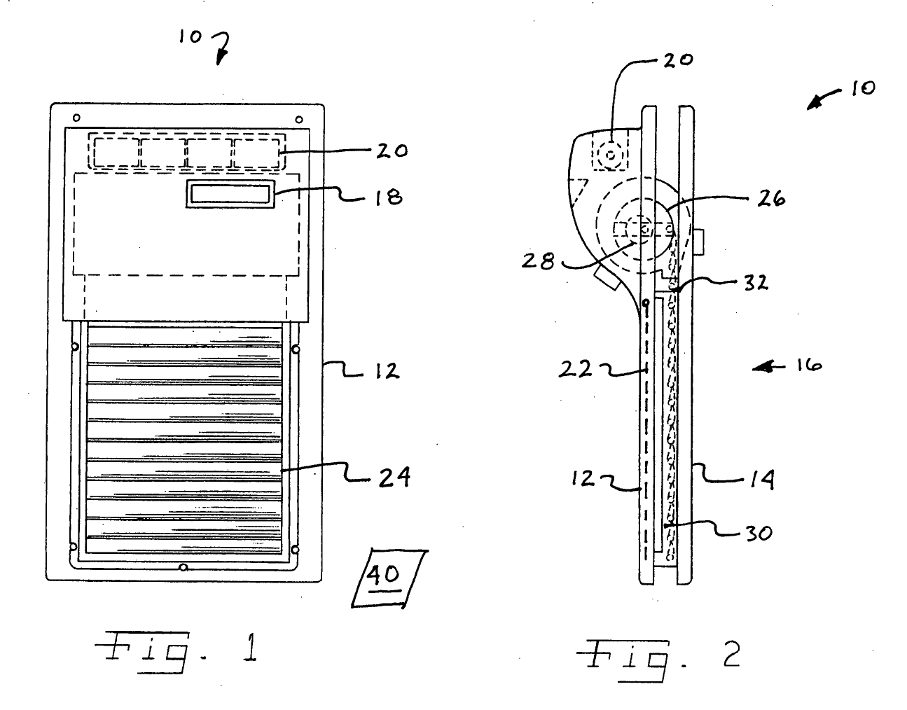

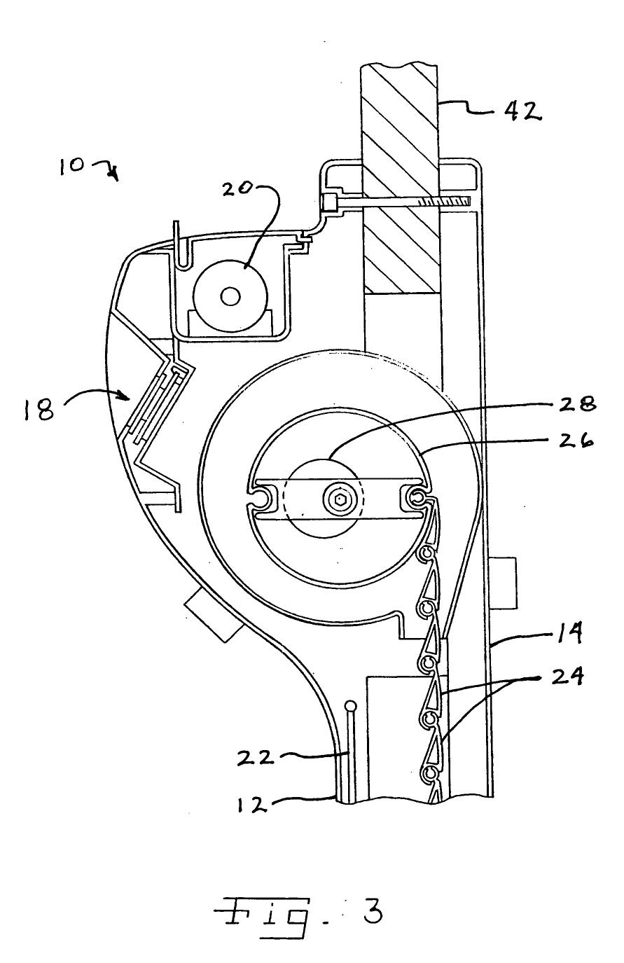

Referring now to the drawings, and, more particularly to FIGS. 1 and 2 there is shown a pet door assembly 10 including an inner frame 12, an outer frame 14, a door assembly 16, a control assembly 18, a power source 20 and a door flap 22. Inner frame 12 and outer frame 14 are mounted on opposite sides of a door or wall and extend beyond the opening therein. Inner frame 12 and outer frame 14 are fastened together through the intervening structure by way of screws or other fasteners.

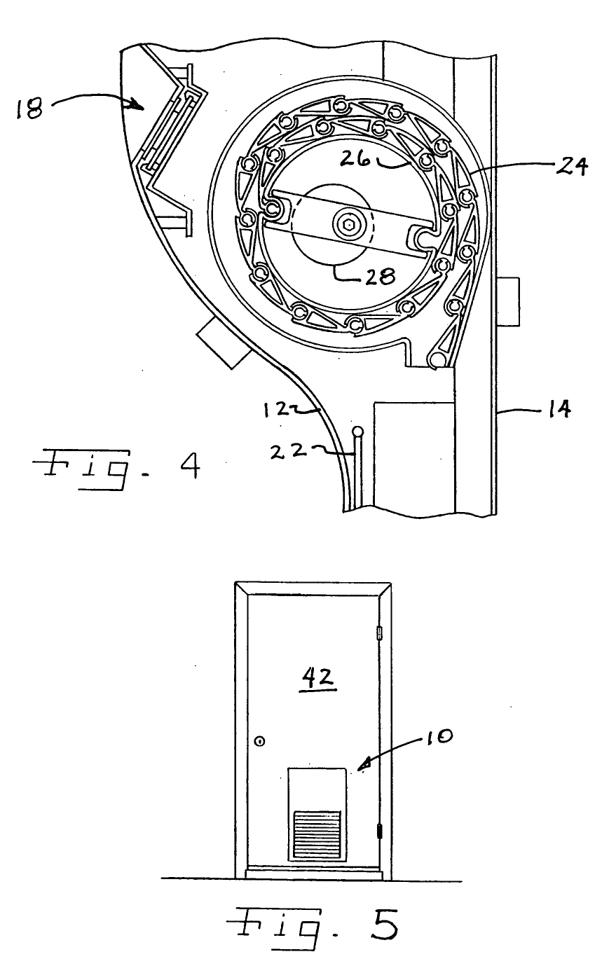

Door assembly 16 includes slats 24, a roller tube 26, a motor 28, tracks 30, and a brush seal 32. Slats 24 are linked together in a rolling manner along the edges of each slat 24. Slats 24 are interconnected yet are able to be wound around roller tube 26. As shown in FIGS. 3 and 4, slats 24 have a cross sectional shape with a hollow interior defining a thermally insulative air gap. Motor 28 is connected to roller tube 26, which supplies power for the rotation of roller tube 26 to thereby wind slats 24 therearound when door assembly 16 is in an open position. Tracks 30 on each side of frames 12 and 14 allow slats 24 to be retained in a substantially vertical manner as door assembly 16 moves slats 24. A brush seal 32 is located along a proportion of outer door frame 14 to seal the mechanism of door assembly 16, to thereby exclude insects and the of air therethrough.

Control assembly 18 includes an operator interface panel allowing an operator to energize the control circuits of assembly 10 and to designate which transmitters 40 will function with assembly 10. Control assembly 18 can also select the amount of time that door assembly 16 is in an open position and the proximity of transmitter 40 to which control assembly 18 should respond. Further, control assembly 18 can be utilized to establish a schedule as to when a transmitter 40 will or will not trigger the opening of door assembly 16 when transmitter 40 is proximate to door assembly 10.

Power source 20 includes batteries, which provide a DC power source to power motor 28 under the control of control assembly 18. Additionally, an AC power source may be utilized to provide power to pet door assembly 10.

Flexible door flap 22 is positioned along one side of door assembly 16 to provide a further barrier for the movement of air through an opening in assembly 10. When a pet wearing transmitter 40 approaches pet door assembly 10 and door assembly 16 is open, door flap 22 reduces the air movement through the opening until the pet passes through the opening. Door flap 22 may be removable.

Transmitter 40 is worn on a pet, preferably on a pet collar, and provides an identification signal, in the form of a keyed transmission, which is detected by door assembly 10 and decoded by control assembly 18 to decide whether or not to open door assembly 16, thereby providing a keyed entry system. A plurality of transmitters 40 may be utilized with control assembly 18 containing information as to which transmitters 40 are to effect the opening of door slats 24.

Assembly 10 can also be thought of as a security shutter 16 that automatically opens and closes when a pet approaches to allow access to an outside or an inside area. Soft flap 22 adds additional protection from the elements while shutter 16 remains open. Shutter 16 provides security, insulation and a weather-proof seal. Control assembly 18 includes circuitry, software and an operator interface, for optical, radio frequency or an RFID interface. The software is used to identify the Identification of the pet and to determine if and when to open and close shutter 16.

The activation of door assembly 10 is accomplished by way of transmitter 40 or an RFID added to a pet's existing collar. Assembly 10 receives a signal from transmitter 40 when the pet is within a preset range, typically 16-36 inches, and the door opens by the activation of motor 28. Motor 28 causes roller tube 26 to rotate, onto which slatted door assembly 16 is wound and unwound. Door assembly 16 remains in an open position for up to five seconds after transmitter 40 is out of range. The user can adjust the range and timing of the door opening by way of control assembly 18. Control assembly 18 may additionally include a battery life indicator.

If transmitter 40 transmits an RF signal, a replaceable battery will be utilized to supply power to transmitter unit 40 on the pet's collar. Alternatively, RFID technology can be utilized to provide identity information relative to the particular pet approaching door assembly 10.

Software within control assembly 18 monitors the battery voltage and when the battery voltage drops to a certain level, the door will not activate to the rollup position. This safety feature prevents the door from remaining in an open position due to a low battery condition. The battery life indicator informs the user of the low battery condition. Additionally, a light curtain or IR screen will sense obstruction in the opening to prevent door assembly 16 from closing if an obstruction is in the opening. Additionally, if the door assembly should contact an item preventing complete closure of the door, the door assembly will reverse to the open position and sound an alarm until the obstruction is removed.

Now, additionally referring to FIGS. 3 and 4, there is shown, in FIG. 3, a view of slats 24 in an extended closed position, and slats 24 are wound onto tube 26 when door assembly 16 is in an open position as shown in FIG. 4.

Now, additionally referring to FIG. 5 there is shown a view of door assembly 10 installed in a residential door 42. The advantage of installing door assembly 10 in residential door 42 is that access on both sides of door 42 is normally maintained so that the pet can approach from either side without difficulty.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A pet door, comprising:
a retracting exterior door revealing a passageway when open; and
an inner flexible door that covers said passageway.

2. The pet door of claim 1, further comprising a keyed entry system associated with said retracting exterior door.

3. The pet door of claim 1, wherein said retracting exterior door includes:
a plurality of slats each interconnected with at least one adjacent one of said plurality of slats; and
a rotating mechanism to accommodate the rolling of said plurality of slats thereonto and therefrom.

4. The pet door of claim 3, wherein said retracting exterior door includes a weather-proof seal.

5. The pet door of claim 3, wherein said inner flexible door includes a thermal insulation portion.

6. The pet door of claim 3, further comprising a control assembly for actuating said rotating mechanism, said control assembly receptive to a keyed transmission.

7. The pet door of claim 6, wherein said keyed transmission is at least one of an electromagnetic transmission and an optical transmission.

8. The pet door of claim 7, wherein said keyed transmission includes an identification signal.

9. A door assembly, comprising:
an exterior entryway door; and
a pet door installed in a lower portion of said exterior entryway door, said pet door including:
a retracting exterior door revealing a passageway when open; and
an inner flexible door that covers said passageway.

10. The door assembly of claim 9, further comprising a keyed entry system associated with said retracting exterior door.

11. The door assembly of claim 10, wherein said retracting exterior door includes:
a plurality of slats each interconnected with at least one adjacent one of said plurality of slats; and
a rotating mechanism to accommodate the rolling of said plurality of slats thereonto and therefrom.

12. The door assembly of claim 11, wherein said retracting exterior door includes a weather-proof seal.

13. The door assembly of claim 11, wherein said inner flexible door includes a thermal insulation portion.

14. The door assembly of claim 11, further comprising a control assembly for actuating said rotating mechanism, said control assembly receptive to a keyed transmission.

15. The door assembly of claim 14, wherein said keyed transmission is at least one of an electromagnetic transmission and an optical transmission.

16. The door assembly of claim 15, wherein said keyed transmission includes an identification signal.

17. A method of operating a pet door, comprising the steps of:
receiving an actuating signal to open a retracting exterior door;
opening said retracting exterior door, thereby revealing a passageway when open; and
keeping said passageway covered by way of an inner flexible door until a pet pushes against said inner flexible door.

18. The method of claim 17, wherein said opening step includes rotating a plurality of slat members of said exterior door around a rotating mechanism.

19. The method of claim 18, wherein said actuating signal is at least one of an electromagnetic transmission and an optical transmission.

20. The method of claim 19, wherein said actuating signal includes an identification signal.
